(19) United States
(12) Patent Application Publication
(10) Pub. No.: US 2003/0043213 A1
(43) Pub. Date: Mar. 6, 2003

(54) Computer controlled user interactive display interface implementation for modifying the scope of selectivity of an on-screen pointer

(75) Inventors: Paul Bernell Finley JR., Austin, TX (US); Michael Douglas Hinegardner, Round Rock, TX (US); Suanne M. Lowe, Austin, TX (US); Jessica Kelley Murillo, Hutto, TX (US); Johnny Meng-Han Shieh, Austin, TX (US)

Correspondence Address: Volel Emile, International Business Machines, Intellectual Property Law Department, 11400 Burnet Road, Internal Zip 4054, Austin, TX, 78758, US

(73) Assignee: International Business Machines Corporation, Armonk, NY

(21) Appl. No.: 09/942,756

(22) Filed: Aug. 30, 2001

(51) Int. Cl. G06F 3/00

(52) U.S. Cl. 345/856

(57) ABSTRACT

Visualizing and modifying the scope of the on-screen pointed, e.g. mouse controlled cursor. The user is enabled to readily modify the scope of his on-screen pointer to a scope which is optimum for any particular icon selection tasks and functions. There is provided a scope of display screen area adjacent said moving pointer within which scope said items are enabled for user selection, and an implementation for enabling a user to interactively modify the scope of said moving pointer. The scope may modified by exposing the normally hidden scope of the pointer and then using the pointer itself to modify the scope. Upon the completion of the modification, the scope may be returned to its hidden state.

### CROSS REFERENCE

United States Patent Applications: TEMPORARILY MOVING ADJACENT OR OVERLAPPING ICONS AWAY FROM SPECIFIC ICONS BEING APPROACHED BY AN ON-SCREEN POINTER ON USER INTERACTIVE DISPLAY INTERFACES (Attorney Docket No. AUS9-2001-0345-US1); DIRECTING USERS' ATTENTION TO SPECIFIC ICONS BEING APPROACHED BY AN ON-SCREEN POINTER ON USER INTERACTIVE DISPLAY INTERFACES (Attorney Docket No. AUS9-2001-0336-US1); and COMPUTER CONTROLLED USER INTERACTIVE DISPLAY INTERFACE IMPLEMENTATION FOR MODIFYING THE SCOPE OF SELECTIVITY OF AN ON-SCREEN POINTER (Attorney Docket No. AUS9-2001-0343-US1), all mailed and filed on Jul. 5, 2001, and all having the assignee of the present application.

### TECHNICAL FIELD

The present invention relates to user interactive computer supported display technology and particularly to such user interactive systems and methods that are user friendly and provide computer users with an interface environment that is easy to use, even in displays which are crowded with icons.

### BACKGROUND OF THE RELATED ART

The past decade has been marked by a technological revolution driven by the convergence of the data processing industry with the consumer electronics industry. This advance has been even further accelerated by the extensive consumer and business involvement in the Internet or World Wide Web (Web) over the past several years. The terms Internet and Web are used interchangeably throughout this application. As a result of these changes, it seems as if virtually all aspects of human endeavor in the industrialized world require human-computer interfaces. These changes have made computer directed activities accessible to a substantial portion of the industrial world's population, which, up to a few years ago, was computer-illiterate, or, at best, computer indifferent.

In order for the vast computer supported industries and market places to continue to thrive, it will be necessary for increasing numbers of workers and consumers who are limited in computer skills to become involved with computer interfaces.

Despite all of the great changes that have been made in the computer industry, the screen cursor controlled manually by the user still remains the primary human-computer interface. The user still commands the computer primarily through manual pointing devices such as mice, joy sticks and trackballs that control the on-screen cursor movements. It must be noted that the principles involved in such pointing devices were developed over a generation ago when most of the people involved in interfaces to computers were computer professionals who were willing to invest great amounts of time in developing computer skills. It is very possible that had computers originally been the mass consumer, business and industry implements which they are today, user interfaces that were much easier and required less skill to use would have been originally sought and developed. Nonetheless, the manually controlled cursor movement devices are our primary access for cursor control. The present invention is directed to making mouse, trackball and the like cursor control devices more user friendly and effective.

Icons in Graphical User Interfaces (GUIs) are, of course, the primary access through which the user may interactively select substantially all computer functions and data. Thus, the number of icons that the user has to contend with in the navigation of his cursor to his target icon has been greatly increasing. These may be arranged in many layers of windows. In certain portions of the user's display screen, there may be dense populations of icons. The icons may overlap or be stacked one on the other.

In addition, the user's desktop display screens have been increasing in size to thereby provide the user with the luxury of some room for icon spacing to visually separate icons. On the other hand, users are extensively using laptop computers and palm-type devices, including Personal Digital Assistants (PDAs), and even cell phone displays to supplement their desktops. Thus, the desktop displays need to be replicated on these smaller screen devices to thereby make the icons even more closely spaced. In any event, whether it be on the desktop, laptop or a smaller screen device, the selection of icons or like displayed objects and items from crowded screen areas presents a problem.

### SUMMARY OF THE PRESENT INVENTION

The present invention offers an implementation for the interactive selection of icons from display screen areas crowded with a high density of icons. The invention provides a user activated cursor control device, such as a trackball or mouse, that is movable in the four orthogonal directions. The control device is connected to the computer which includes means for converting the user activated orthogonal movements into cursor or pointer movements in said four directions. The key to the present invention is in the user having the capability of visualizing and modifying the scope of the on-screen pointer, e.g. mouse controlled cursor. Every pointer in on-screen displays has its particular scope, i.e. the range or area adjacent to the cursor within which the user, through the cursor, may select displayed items or otherwise affect such items or icons. Conventionally, such pointer scopes are fixed or predetermined by the provider of the operating system's graphics. However, in the present environment of GUIs, icons may be distributed on the screen in many different densities, i.e. numbers of icons per unit area, in many different sizes, as well as in many different layers of windows. Accordingly, any predetermined scope for an icon may be awkward for selection in certain icon distribution display screen layouts. The present invention provides the user with the capability of readily modifying the scope of his on-screen pointer to a scope which is optimum for any particular icon selection tasks and functions. In a display screen environment with user controlled means for moving an on-screen pointer to approach said selectable items, there is the combination of means for providing a scope of display screen area adjacent said moving pointer within which scope said items are enabled for user selection, and means for enabling a user to interactively modify said scope of said moving pointer. The scope may be modified by exposing the normally hidden scope of the pointer and then using the pointer itself to modify the scope. Upon the completion of the modification, the scope may be returned to its hidden state. The scope may also be modified through user interactive dialog means involving interactive selections from displayed menus and dialog boxes.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a generalized data processing system including a central processing unit that provides the computer controlled interactive display system which may be used in practicing the present invention;

FIG. 2 is a diagrammatic view of a display screen illustrating an example of a cursor movement toward a target icon in a crowded icon environment with the normally hidden scope of the cursor shown in dashed lines;

FIG. 3 is the view of FIG. 2 during the cursor scope modification method of this invention whereby the scope is displayed;

FIG. 4 is the view of FIG. 3 at a subsequent cursor scope modification stage wherein the cursor itself is used to modify the cursor scope;

FIG. 5 is a partial view of FIG. 4 at a subsequent modification stage wherein the scope of the cursor has been reduced in size by the modification;

FIG. 6 is the partial view of FIG. 5 upon the completion of the cursor scope modification wherein the scope has been returned to its normally hidden state, and the cursor is returned to its initial state and position;

FIG. 7 is a partial view like that of FIG. 6 to illustrate a change in the geometric configuration of a cursor scope in accordance with this invention;

FIG. 8 is a partial view like that of FIG. 6 to illustrate a change in the position of a cursor scope in accordance with this invention;

FIG. 9 is a partial view like that of FIG. 6 to illustrate a change in the size of a cursor scope in accordance with this invention;

FIG. 10 is an illustrative view of a portion of a display screen to illustrate an embodiment for changing the cursor scope through a sequence of interactive user selections from a sequence of menus;

FIG. 11 is a flowchart of the program steps involved in setting up a process of the present invention for changing the scope of a cursor; and

FIG. 12 is a flowchart of the steps involved in an illustrative run of the process set up in FIG. 11.

### DETAILED DESCRIPTION OF THE PREFERRED EMBODIMENT

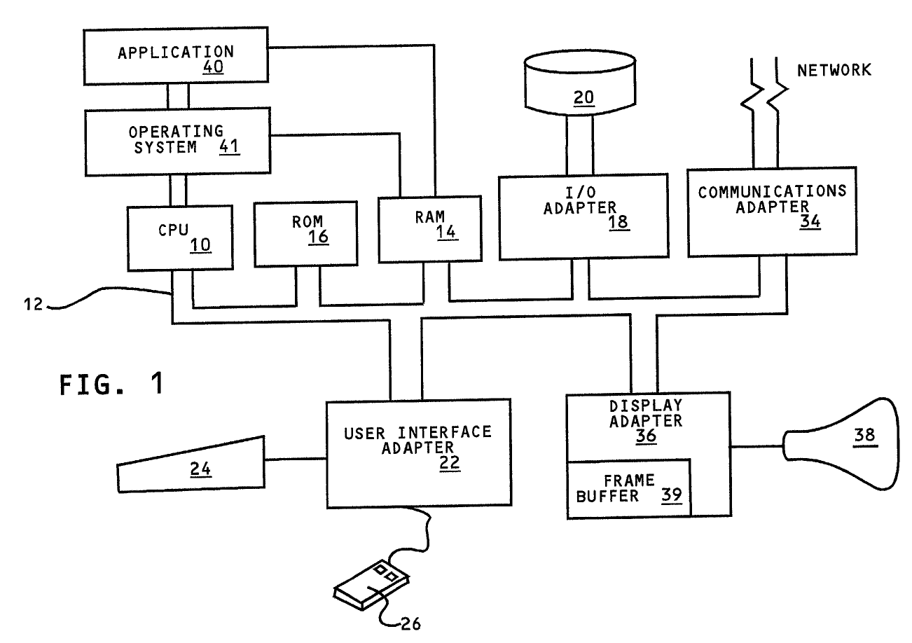

Referring to FIG. 1, a typical data processing system is shown that may function as the computer controlled display terminal used in implementing the system of the present invention of the interactive user to modify the scope of his pointer, e.g. cursor, so as to optimize its effective use in differing icon distribution display interface environments. A central processing unit (CPU) 10, such as any PC microprocessor in a PC available from International Business Machines Corporation (IBM) or Dell Corp., is provided and interconnected to various other components by system bus 12. An operating system 41 runs on CPU 10, provides control and is used to coordinate the function of the various components of FIG. 1. Operating system 41 may be one of the commercially available operating systems such as Microsoft's Windows98™ or WindowsNT™, as well as the UNIX or IBM's AIX operating systems. An application program for permitting the user to display and then modify the scope of his cursor to be subsequently described in detail, runs in conjunction with operating system 41 and provides output calls to the operating system 41, which in turn implements the various functions to be performed by the application 40. A Read Only Memory (ROM) 16 is connected to CPU 10 via bus 12 and includes the Basic Input/Output System (BIOS) that controls the basic computer functions. Random Access Memory (RAM) 14, I/O adapter 18 and communications adapter 34 are also interconnected to system bus 12. It should be noted that software components, including operating system 41 and application 40, are loaded into RAM 14, which is the computer system's main memory. I/O adapter 18 may be a Small Computer System Interface (SCSI) adapter that communicates with the disk storage device 20, i.e. a hard drive. Communications adapter 34 interconnects bus 12 with an outside network enabling the data processing system to communicate with other such systems over a Local Area Network (LAN) or Wide Area Network (WAN), which includes, of course, the Internet. I/O devices are also connected to system bus 12 via user interface adapter 22 and display adapter 36. Keyboard 24 and mouse 26 are all interconnected to bus 12 through user interface adapter 22. Mouse 26 operates in a conventional manner insofar as user movement is concerned. Display adapter 36 includes a frame buffer 39, which is a storage device that holds a representation of each pixel on the display screen 38. Images may be stored in frame buffer 39 for display on monitor 38 through various components such as a digital to analog converter (not shown) and the like. By using the aforementioned mouse or related devices, a user is capable of inputting information to the system through the keyboard 24 or mouse 26 and receiving output information from the system via display 38.

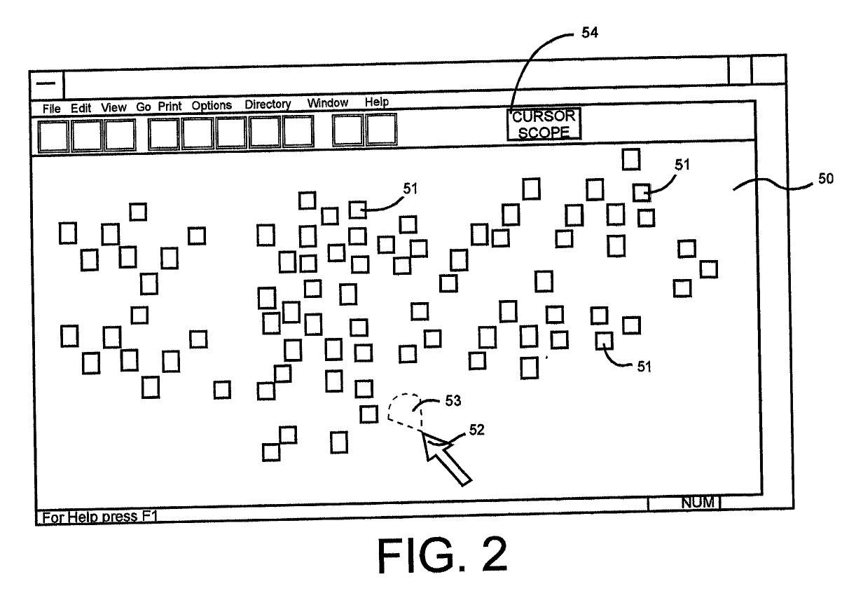

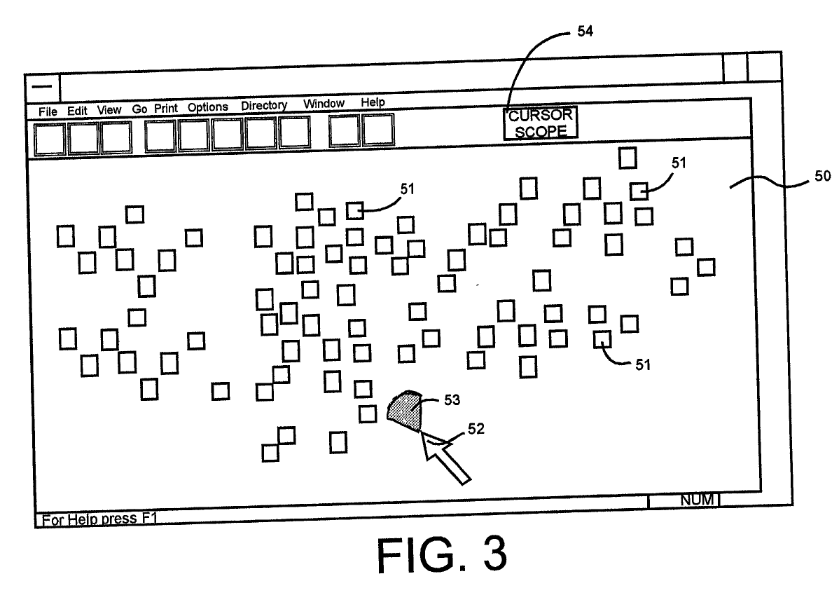

With reference to FIG. 2, the display screen 50 shown has a great number of icons 51 of various shapes, sizes and arrangements in the X, Y and Z coordinate directions (simplified to just squares for illustration). Actually the number, sizes and shapes of icons has also been minimized for this example. Thus, as the cursor 52 is moved along and approaches target icons, it is understood that there may be icons arranged in patterns of greater or lesser icon density, i.e. greater spacing between icons, and the icons may be of varied sizes and shapes. Every pointer, e.g. cursor 52, has a scope 53 or a range of selectivity within which any icon would be selectable by the user. This scope is usually predetermined by the designer of the operating system providing the GUI being used. This scope is often arcuate and frequently a semi-circle with the point of the pointer as the center. In normal operation, this scope 53 is not visible or hidden as indicated by the dashed lines. It should be understood that with differing distributions, sizes and shapes of icons, different pointer or cursor 52 scopes 53 could provide optimum cursor effectiveness in these differing situations. Thus, the present invention provides the user with the means for modifying the scope 53 of cursor 52. When the user picks item 54 “Cursor Scope” from the menu bar, then, as shown in FIG. 3, the hidden cursor scope 53 becomes visible and even highlighted. This selection of item 54 may be made with the cursor itself or the selection may be made using the keyboard.

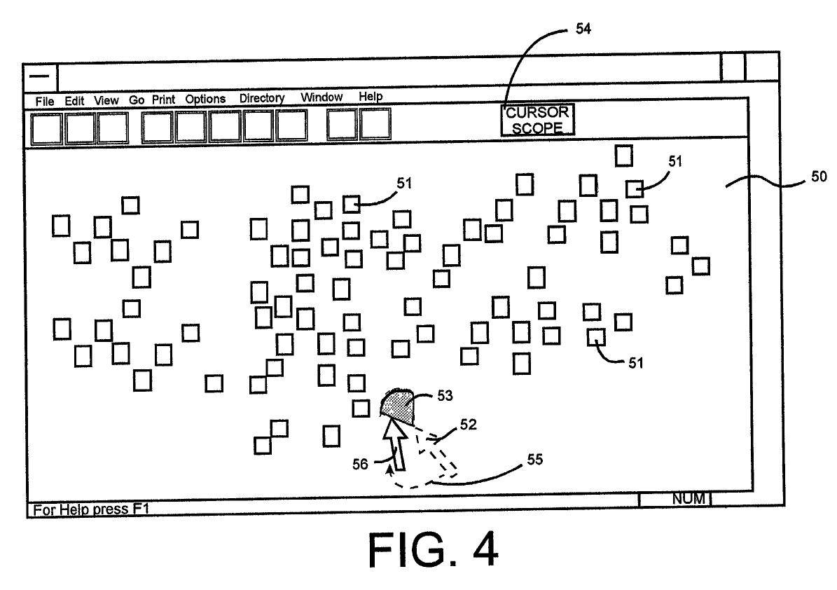

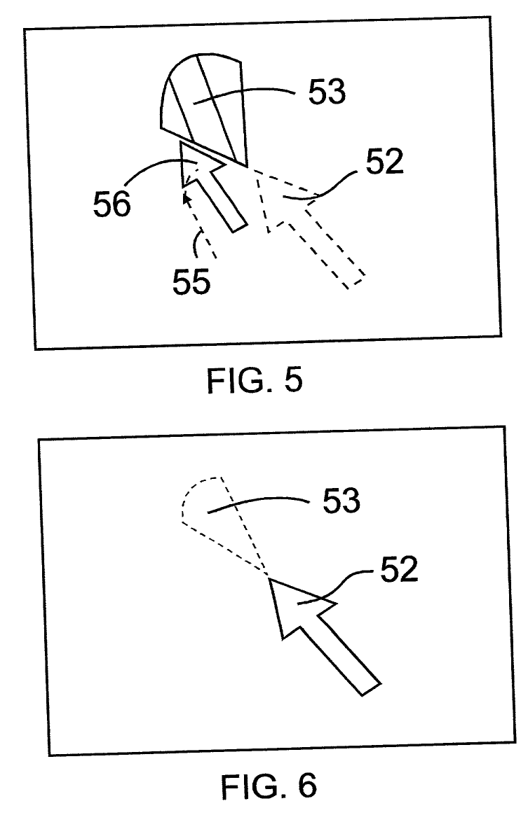

At this point, the visible scope 53 may be modified using any conventional graphics techniques, i.e. as shown in FIG. 4 the cursor itself may be used, the cursor shown as cursor 56 is moved from its original position 52 indicated in dashed lines along path 55 to the lower side of scope 53. Then, as shown in the partial enlarged view of FIG. 5, the cursor continues to push the lower side until the area of scope 53 is greatly reduced. When the user has completed his modification of scope, he may indicate this by again pressing the Cursor Scope item 54 on the menu bar (FIG. 4), and, as shown in FIG. 6, modified scope 53 again resumes its normally hidden state and cursor 52 is returned to its original position from which it may continue its approach to its target icon with more optimum scope.

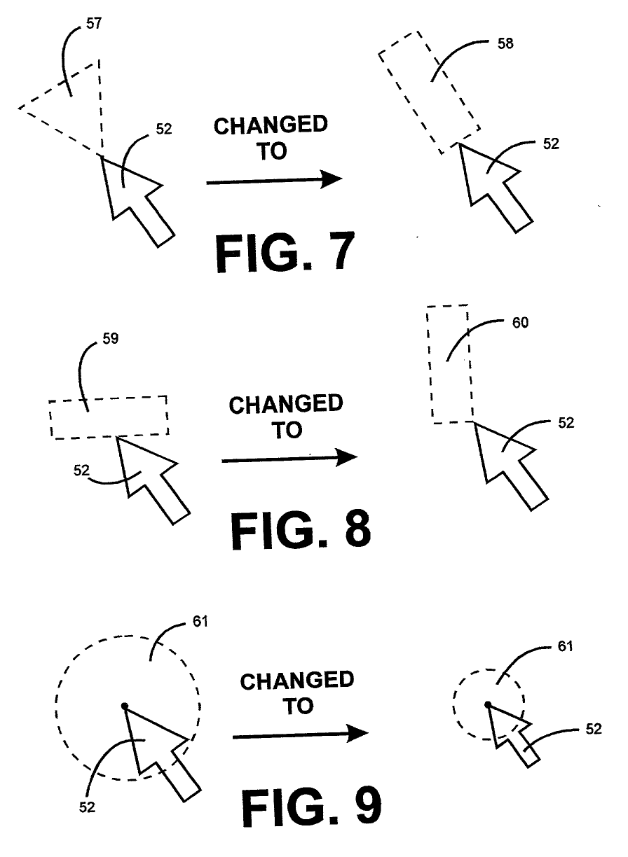

FIGS. 7 through 9 are shown to illustrate other types of pointer or cursor scope modification which may be made in the present invention. In FIG. 7, a triangular scope area 57 is changed to a rectangular area 58, an example of a change in geometric configuration. In FIG. 8, an elongated rectangle scope 59 is initially in a horizontal position. This is an optimum position if the cursor 52 were to be used in selecting a group of relatively wide icons arranged in vertical columns; the cursor 52 could sweep its scope 59 vertically up a column of icons. Then, if circumstances change, and the cursor 52 were to be used to select a similar group of icons in a row, the position of the scope could then be modified to scope 60. As shown in FIG. 9, circular scope 61 could be reduced in size if optimization so required.

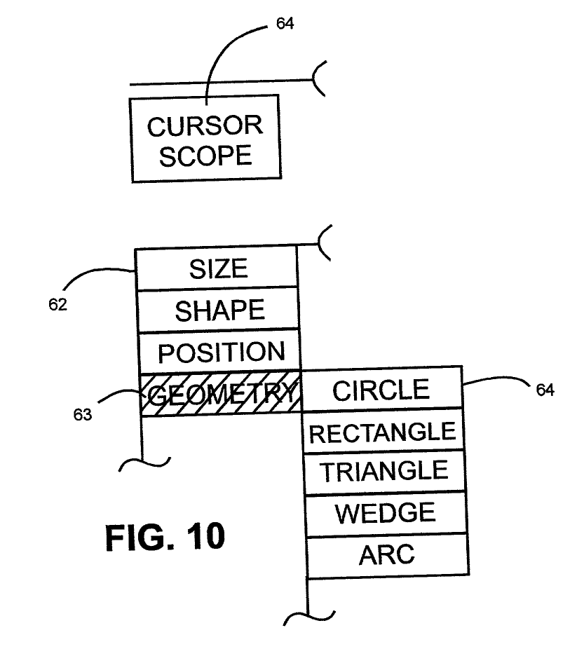

As shown in FIG. 10, the cursor scope could be modified through the use of an interactive user dialog involving a sequence of menus. In the partial view of a display screen shown in FIG. 10, when the user presses “Cursor Scope” item 54 in addition to the normally hidden cursor scope 53 being revealed as shown in FIG. 3, a drop down menu 62 appears listing a set of first choices offered to the user in the modification of the cursor scope. In this example, the user has selected to change the “Geometry” 63 which results in a next menu 64 offering geometric configuration choices for the change.

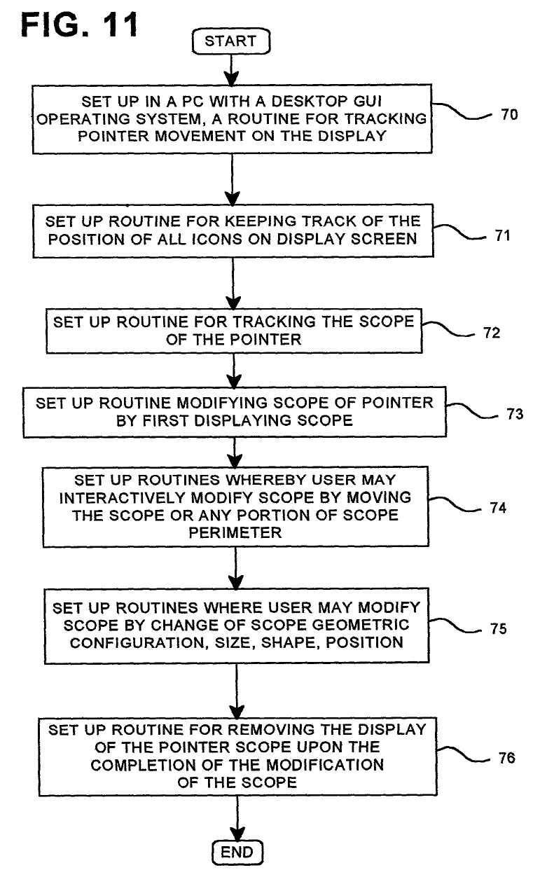

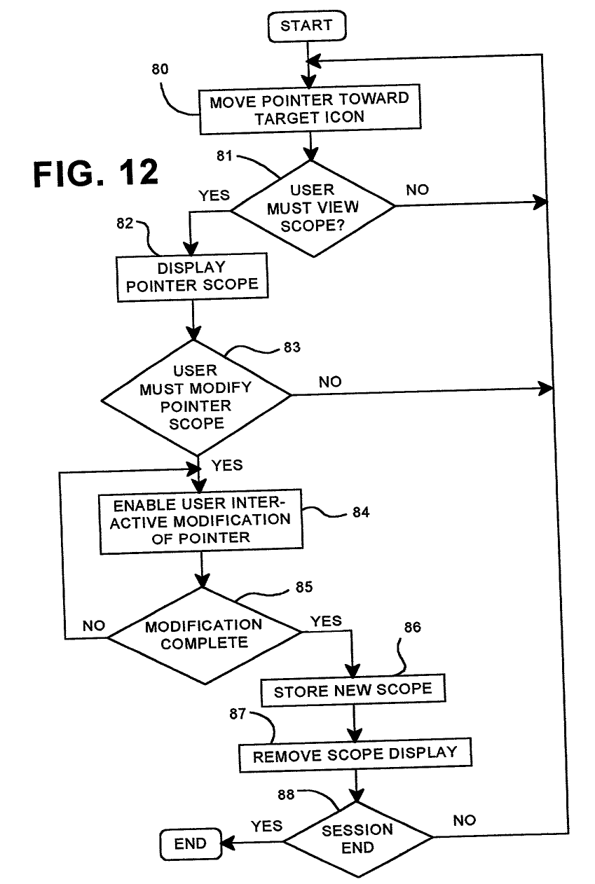

Now, with reference to FIGS. 11 and 12, we will describe a process implemented by the present invention in conjunction with the flowcharts of these figures. FIG. 11 is a flowchart showing the development of a process according to the present invention for modifying the scope of icons. In a personal computer set up with a desktop GUI and an operating system, a routine is provided for tracking cursor movements between points on a display screen, step 70. A routine is provided for tracking cursor positions on the display screen, step 71. A routine is also set up for tracking the scope of the cursor, step 72. A routine is set up for modifying the scope of the cursor that involves first displaying the scope of the cursor, step 73. Routines are set up whereby a user may interactively modify the scope by moving the scope or some portion of the scope perimeter, step 74. Routines are set up whereby the user may modify the scope's geometric configuration, size shape or position, step 75. Finally, a routine is set up for removing the display of the scope upon the completion of the modification of the scope, step 76.

An illustrative running of the process of FIG. 11 will now be described with respect to FIG. 12. First, step 80, the cursor is moved in the direction of an icon that the user wishes to select. A determination is made, step 81, as to whether the user feels that the default or normal scope of his cursor is likely to be satisfactory in the display screen environment. If the user is satisfied with the scope, the determination from step 81 is No, he does not need to view the cursor scope, and he continues to move the cursor, step 80. If the determination from step 81 is Yes, the user needs to view the cursor scope, he displays the scope, step 82, and then makes a determination, step 83, as to whether the scope is such that he needs to modify it in order to optimize his cursor navigation and selection in the present icon distribution environment, then the determination is Yes, the process for modification is enabled so that the user may make suitable modifications, step 84. Upon the completion of the modification as determined in step 85, the new scope of the cursor is stored, step 86, and the displayed cursor scope is again hidden, step 87. If at step 83, the user had decided No, then the scope need not be modified and he continues to move the cursor, step 80. Upon the completion of step 87, a determination may conveniently be made as to whether the session is at an end, step 88. If Yes, the session is exited; if No, the process is branched back to step 80 where the user continues to move the cursor.

In the example given, the displayed scope of the cursor is hidden after it is modified. The scope of the cursor need not be hidden during any navigation or selection process. It may remain visible during such processes. Also, the pointer or cursor is shown only pointing a single direction. It should be understood that the pointer may be pointed in any desired direction, and, particularly, in the direction of navigation. IBM copending application Serial No. 09/282,635, filed Mar. 31, 1999, entitled A Graphical User Interface for a Computer Oriented Display With a Self-Orienting Pointing Cursor, M. F. Davis et al., assigned to the assignee of the present invention, hereby incorporated by reference, discloses examples of such pointers.

One of the implementations of the present invention is as an application program 40 made up of programming steps or instructions resident in RAM 14, FIG. 1, during computer operations. Until required by the computer system, the program instructions may be stored in another readable medium, e.g. in disk drive 20 or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In a computer controlled user interactive display system, a display interface implementation for enabling an interactive user to select specific items on a display screen comprising:
user controlled means for moving an on-screen pointer to approach said selectable items;
means for providing a scope of display screen area adjacent said moving pointer within which scope said items are enabled for user selection; and
means for enabling a user to interactively modify said scope of said moving pointer.

2. The display system of claim 1 wherein said items are icons.

3. The display system of claim 2 wherein said scope may be modified without changing the image of said pointer.

4. The display system of claim 3 wherein said scope may be modified by changing the geometric configuration of the scope.

5. The display system of claim 3 wherein said scope may be modified by changing the size of the scope.

6. The display system of claim 3 wherein said scope may be modified by changing the position of the scope.

7. The display system of claim 3 wherein said scope is circular.

8. The display system of claim 3 wherein said scope is rectilinear.

9. A method for enabling an interactive user to select specific items on a display screen in computer controlled user interactive display systems comprising:
moving an on-screen pointer to approach said selectable items;
providing a scope of display screen area adjacent said moving pointer within which scope said items are enabled for user selection; and
enabling a user to interactively modify said scope of said moving pointer.

10. The method of claim 9 wherein said items are icons.

11. The method of claim 10 wherein said scope may be modified without changing the image of said pointer.

12. The method of claim 11 further including the steps of
displaying the scope of the moving pointer on said display screen prior to modification; and
removing said scope from the display screen after any modification.

13. The method of claim 12 wherein said scope may be modified by changing the geometric configuration of the scope.

14. The method of claim 12 wherein said scope may be modified by changing the size of the scope.

15. The method of claim 12 wherein said scope may be modified by changing the position of the scope.

16. The method of claim 12 wherein said scope is circular.

17. The method of claim 12 wherein said scope is rectilinear.

18. A computer program having program code included on a computer readable medium for enabling an interactive user to select specific items on a display screen in a computer controlled user interactive display system comprising:
user controlled means for moving an on-screen pointer to approach said selectable items;
means for providing a scope of display screen area adjacent said moving pointer within which scope said items are enabled for user selection; and
means for enabling a user to interactively modify said scope of said moving pointer.

19. The computer program of claim 18 wherein said items are icons.

20. The computer program of claim 19 wherein said scope may be modified without changing the image of said pointer.

21. The computer program of claim 20 wherein said scope may be modified by changing the geometric configuration of the scope.

22. The computer program of 20 wherein said scope may be modified by changing the size of the scope.

23. The computer program of 20 wherein said scope may be modified by changing the position of the scope.

24. The computer program of claim 20 wherein said scope is circular.

25. The computer program of claim 20 wherein said scope is rectilinear.
